(19) United States
(12) Patent Application Publication
(10) Pub. No.: US 2024/0315261 A1
(43) Pub. Date: Sep. 26, 2024

(54) COMPLETE PLANT-BASED PROTEIN PRODUCT AND SYSTEM AND METHOD FOR MAKING THE SAME

(71) Applicant: Reza Soltanzadeh, Saluda, SC (US)

(72) Inventor: Reza Soltanzadeh, Saluda, SC (US)

(21) Appl. No.: 18/589,271

(22) Filed: Feb. 27, 2024

Related U.S. Application Data
(60) Provisional application No. 63/449,028, filed on Feb. 28, 2023.
(60) Provisional application No. 63/449,029, filed on Feb. 28, 2023.
(60) Provisional application No. 63/530,682, filed on Aug. 3, 2023.
(60) Provisional application No. 63/598,492, filed on Nov. 13, 2023.

(51) Int. Cl. A21D 2/26; A21D 10/00; A21D 13/066; A21D 13/60

(52) U.S. Cl. CPC A21D 2/266; A21D 10/005; A21D 13/066; A21D 13/60

(57) ABSTRACT

The present invention provides a novel combination of plant-based food groups in order to create a plant-based complete protein product that delivers an adequate proportion of all nine essential amino acids. A complete protein, often provided through animal-based food products, contains an adequate proportion of each of the nine essential amino acids. The present invention provides a novel combination of legumes and grains to create a plant-based complete protein product which can be further combined with additional ingredients to form a consumable dough containing plant-based complete protein.

### CROSS REFERENCE TO RELATED APPLICATIONS

This application claims the benefit of U.S. Provisional Patent Application Ser. No. 63/449,028 filed Feb. 28, 2023, U.S. Provisional Patent Application Ser. No. 63/449,029, filed Feb. 28, 2023, U.S. Provisional Patent Application Ser. No. 63/530,682 filed Aug. 3, 2023, and U.S. Provisional Patent Application Ser. No. 63/598,492 filed Nov. 13, 2023, the contents of which are incorporated herein by reference in their entirety.

### BACKGROUND OF THE INVENTION

The present invention is directed to a system and method for combining legumes and grains to create a complete plant-based protein product for consumption. Plant-based diets are gaining popularity and driving the development of plant-based protein alternatives. However, many popular plant-based protein alternatives fail to provide the consumer with a complete protein source.

A complete protein, often consumed from animal-based food products, contains an adequate proportion of each of the nine essential amino acids and has a Protein Digestibility Corrected Amino Acid Score (“PDCAAS”) of 1.0, according to the Food and Drug Administration (“FDA”). The nine essential amino acids that make up a complete protein when combined in specific proportions are histidine, isoleucine, leucine, lysine, methionine, phenylalanine, threonine, tryptophan, and valine.

Plant-based diets have recently grown in popularity as a means for reducing the negative environmental impacts associated with animal farming and as a means for increasing one's overall health. The term “plant-based” refers to food items which do not contain any animal products such as meat, dairy, and other animal products. While plant-based diets have been shown to have a significantly lower environmental impact than animal-based diets, plant-based diets often fail to provide a consumer with a substantial source of complete protein.

Legume protein, a common plant-based alternative to whey protein powders and supplements, does not contain an adequate amount of each of the nine essential amino acids and has a PDCAAS score of 0.83, therefore failing to meet the criteria for a complete protein unlike whey, which has a PDCAAS score of 1.0. The present invention provides a novel combination of plant-based food groups in order to create a plant-based complete protein source that delivers an adequate proportion of all nine essential amino acids. Furthermore, the present invention provides a complete protein to a consumer at a much lower environmental cost, further decreasing the negative environmental impacts of the food industry.

Low glycemic index (“GI”) diets have been growing in popularity as a means for weight control and overall improvement in health and wellness. The GI is a rating system for foods containing carbohydrates, wherein pure glucose has a GI value of 100. Specifically, GI is used to determine how much a certain food item can affect blood sugar levels. Several factors including ripeness, nutrient composition, cooking method, amount of processing, and other factors can impact a food item's GI value. The lower the GI value of a certain food, the less it may affect one's blood sugar when consumed. Foods associated with a low GI include foods high in protein, fat, or fiber. Foods that do not contain carbohydrates are not assigned a GI value. Research has shown that diets with low GI value aid in prevention of coronary heart disease in both diabetic and health individuals. In obese and overweight individuals, low GI meals were shown to increase satiety and facilitate control of food intake. One embodiment of the present invention provides a low GI, plant-based, complete protein dough product.

Current research is suggesting the importance of a high protein, whole grain diet. In fact, studies have shown that a whole-grain diet increases whole-body protein balance compared to a refined-grain diet by promoting a higher protein turnover. Whole grain diets have also been shown to increase protein synthesis in muscle cells and are associated with greater muscle function in older adults when compared to individuals consuming a refined-grain diet, showing long-term benefits to increasing whole grain consumption.

In one embodiment, the present invention provides a novel combination of plant-based complete protein with whole grains to create a nutrient-rich consumable product. The importance of whole grains in a standard diet is becoming highly recognized with efforts made by the United States Department of Agriculture (“USDA”) to increase the presence whole grains in school meals.

Whole grains contain three layers consisting of the bran, the endosperm, and the germ. The bran is a fiber-filled outer layer rich with vitamins and minerals. The endosperm is a starchy carbohydrate containing some protein and vitamins, and the germ is a nutrient-packed core with vitamins including B and E vitamins, phytochemicals, and healthy fats. Refined grain consists only of the endosperm and is therefore lacking the most nutrient-rich elements of whole grain.

The USDA has set a requirement that 80% of grains offered in school lunches should be whole grain-rich, meaning they must contain at least 50% whole grains, while the other 50% must be either enriched, bran, or germ. One embodiment of the present invention provides a consumable, shelf-stable plant-based product that meets the FDA standards for complete protein and the USDA standards for adequate whole grains for school lunches.

The present invention offers a nutritious, complete protein and whole grain rich product which is shelf-stable and can be individually packaged and shipped in bulk for widespread distribution. In some embodiments, the present invention may provide a cost-effective solution for providing shelf-stable nutrient meals to various locations and institutions including academic military, penal, and other institutions which may provide meals to a group of people.

### SUMMARY OF THE INVENTION

The present invention pertains to a system and method for combining legumes and grains to create a complete plant-based protein product for consumption. Legumes such as green or yellow (any peas, etc.) peas are a nutritious food containing high amounts of protein and fiber. However, peas alone are not a source of complete protein because they do not contain an adequate amount of all nine essential amino acids and have a PDCAAS less than 1.0. By combining a legume such as green or yellow peas (or any peas, etc.) with a grain such as wheat, a product that contains adequate amounts of all nine essential amino acids is created. The product of this combination is a plant-based source of complete protein.

Proteins are made up of amino acids, which are organic compounds that contain both amino and carboxylic acid functional groups. Not all proteins are functionally and chemically alike. Although hundreds of amino acids have been identified, there are only twenty amino acids that make up the proteins in the human body. Nine of those twenty amino acids are considered essential, meaning they are not produced by the body alone and must be consumed in one's diet. Lysine, one of the nine essential amino acids, plays a key role in calcium absorption and collagen production. A complete protein is defined by the FDA as having a PDCAAS of 1.0. A complete protein should contain an adequate proportion of each of the nine essential amino acids, including lysine.

The present invention discloses a method for creating a protein-rich dough product that is derived from grains and legumes which are specifically combined to have a PDCAAS of 1.0, making it a truly functional, complete protein. The protein provided in the present invention is complete and designated as an excellent source of protein according to the FDA regulations.

In one embodiment of the present invention, legume protein is combined with grain protein to produce a plant-based complete protein product. The grain protein and the legume protein product may be combined with a flour and water to form a dough which contains plant-based complete protein. This dough may then be formed into a desired shape and cooked for consumption. In one embodiment, the dough is formed into a noodle shape and cooked via steaming, frying, boiling, or other method or some combination thereof. This cooked product can be dried, portioned, packaged, and shipped for distribution. Once packaged, the final product is shelf-stable. In some embodiments, dehydrated vegetables and spices may be included in the package before sealing the product in the package. When ready to be consumed, the product may be rehydrated and cooked using boiling water or other liquid and allowed to cool for a specific period of time prior to consumption. The product may also be consumed as packaged, without additional cooking or other preparation.

In an alternative embodiment, the flour is gluten-free, and the product is a gluten-free plant-based complete protein dough which may be shaped, cooked, dried, and packaged. In another alternative embodiment, at least a portion of the flour is whole grain flour, and the product is a whole grain containing plant-based complete protein dough which may be shaped, cooked, dried, and packaged. In another alternative embodiment, the flour may be a flour having a low glycemic index. In this alternative embodiment of the present invention, the plant-based complete protein dough product may be developed to have a low GI value. In this alternative embodiment, the product is a low GI plant-based complete protein dough which may be shaped, cooked, dried, and packaged as according to the preferred embodiment.

In one embodiment of the present invention, the plant-based complete protein is combined with a whole grain flour. Specifically, the proportion of whole grain flour may be a quantity of such that meets the USDA whole grain requirements for school provided meals. The addition of whole grains into the present invention increases the nutritional quality while still maintaining an ideal taste, texture, and consistency.

In alternative embodiments, the legume protein may be sourced from green peas, yellow peas (any peas, etc.) or other plant-based protein sources, for example other legume-derived protein and the wheat protein may be replaced with other similar grain-based protein sources. In the preferred embodiment, the end-product is a dough containing complete plant-based protein that may be used to form noodles, pasta, or other dough-based products.

Because the present invention offers a shelf-stable complete protein, it is ideal for production and distribution to various institutions which are responsible for providing nutritious meals to a group of people. These institutions may include academic institutions, military institutions, penal institutions, volunteer-based institutions, housing institutions, healthcare institutions, or other institutions.

In an alternative embodiment for the present invention, the final packaged product may be uniquely designed for a specific consumer. In this alternative embodiment, the plant-based complete protein dough is packaged in a container having a quick-response (“QR”) code or other similar printed label which, when scanned, redirects the nutritional information of the product to a consumer's health and wellness application on said consumer's electronic device. This allows for a product to be directly tailored to a consumer, and for a consumer to be sure that the product they are consuming will provide them with an ideal combination of nutrients including whole grains, proteins, carbohydrates, fats, vitamins, minerals, and other nutrients for their unique dietary needs and preferences.

In the alternative embodiment, data may be collected from a consumer including dietary trends and health data including height, weight, personal medical history, family medical history, and other relevant information. This data can then be stored in a database accessible to at least one processor configured to store computer-executable instructions, which when activated, cause said processor to analyze said data and determine a diet plan which will maintain or increase a consumer's overall wellness by providing a unique formula of micro and macro nutrients. This diet plan may then be used to produce a consumable product in accordance with said diet plan which can then be distributed to the consumer. In one embodiment, the consumer may then provide updates and feedback based on said consumable product in order to better personalize the product to the consumer's preferences.

Many individuals with health conditions such as diabetes are required to closely monitor their diet to avoid unwanted health complications. The present invention provides an opportunity to tailor a shelf-stable consumable product to an individual's specific dietary needs in order to maintain a healthy diet and avoid unwanted health complications. The formula for the consumable product may be altered and developed to aid in weight management, cholesterol management, blood sugar management, or other health managements. The consumable product may be designed specifically for individuals with a plurality of health conditions including but not limited to diabetes, obesity, cardiovascular disease, hypertension, cancers, celiac disease, allergies, neurological disorders, and other health disorders.

In one embodiment, a plurality of data relating to individual, community, and population diet trends may be collected in order to tailor a product to said individual, community, or population. For example, and not by way of limitation, dietary trend or other relevant data collected from children between the of ages 10 and 18, may be analyzed to determine a formula for a consumable product tailored to provide the ideal combination of macro and micronutrients for the selected group. In this example, the product developed based on the analyzed data may then be distributed to a plurality of populations of children between the ages of 10 and 18 via school meals or other means. This process can be applied to other groups to provide a uniquely tailored consumable product based on said group's dietary needs as determined by said data analysis. The consumable product may also be made widely available via commercial production means and other methods of commerce.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a flow chart of the life cycle stages of the present invention.

FIG. 2 is a chart containing the environmental conditions required during the manufacturing process.

FIG. 3 is a chart containing the nutritional information of the present invention.

FIGS. 4A-B shows the steps of the method of the present invention.

FIG. 5 summarizes the basic elements of the invention.

FIG. 6 shows an exemplary legume protein data sheet.

FIG. 7 shows an exemplary first grain data sheet.

FIG. 8 shows an exemplary second grain data sheet.

### DETAILED DESCRIPTION OF THE PREFERRED EMBODIMENT

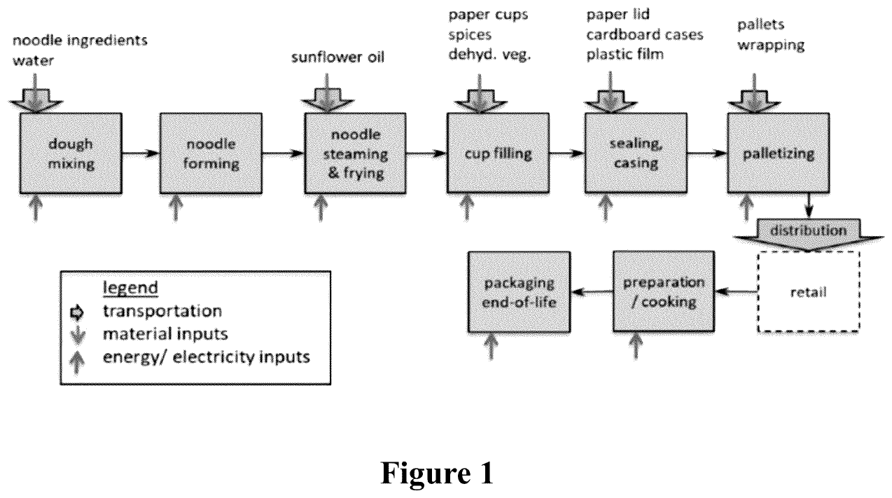

FIG. 1 is a flow chart of the life cycle stages of the present invention. In accordance with the preferred embodiment of the present invention, the manufacturing process begins with forming the dough. This dough may be used, in some embodiments, to form instant cooking noodles. The dry ingredients are mixed with water in order to form said dough, and once the dough has formed, the noodles are formed from the dough. Once the noodles are formed, they are cooked in a neutral oil, for example sunflower oil, and are steamed and fried. Once the noodles are cooked and portioned into individual servings, they are packaged in a food safe container along with spices and dehydrated vegetables specific to the flavor of the product. The term “spices” should be understood to encompass any edible aromatic vegetable or other substance used to provide flavor to food, for example and not by way of limitation, spices may include salt, pepper, cumin, paprika, garlic, and other similar dried, ground compounds. Once all ingredients have been added into the container, a lid is added and sealed, each container is placed on a pallet of several containers, the pallet is wrapped, and the product is distributed to retailers.

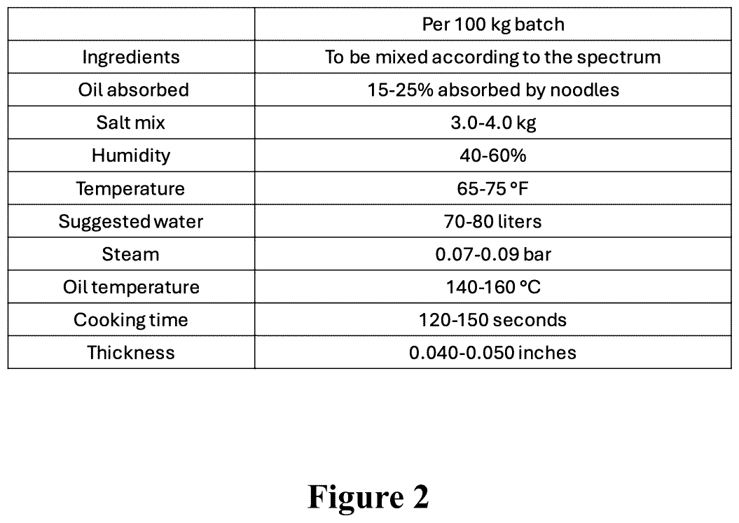

FIG. 2 is a chart containing the specific environmental conditions required during the manufacturing process. In accordance with the preferred embodiment of the present invention, several aspects must be considered in order to produce the exact composition desired. These aspects include but are not limited to the temperature in the room during production, the temperature of the oil used to cook the noodles, the humidity of the room during production, the amount of water used, the amount of steam used, the speed at which the components are combined, and the time it takes to cook the noodles before drying and packaging. In one example, but not by way of limitation, per 100 kg batch, 15-25% of oil used for frying the dough will be absorbed by the dough product as it fries. Between 3.0-4.0 kg of a plurality of salts (referred to as the “salt mix”) may be added. the environment humidity is maintained between 40-60%, the environment temperature is maintained between 65-75 degrees Fahrenheit, the added water is between 70-80% by weight, the steam used is maintained between 0.07-0.09 bar, the oil temperature used for frying is maintained between 140-160 degrees Celsius, the speed is between 120-150 seconds, and the thickness of the dough noodle product is between 0.040-0.050 inches.

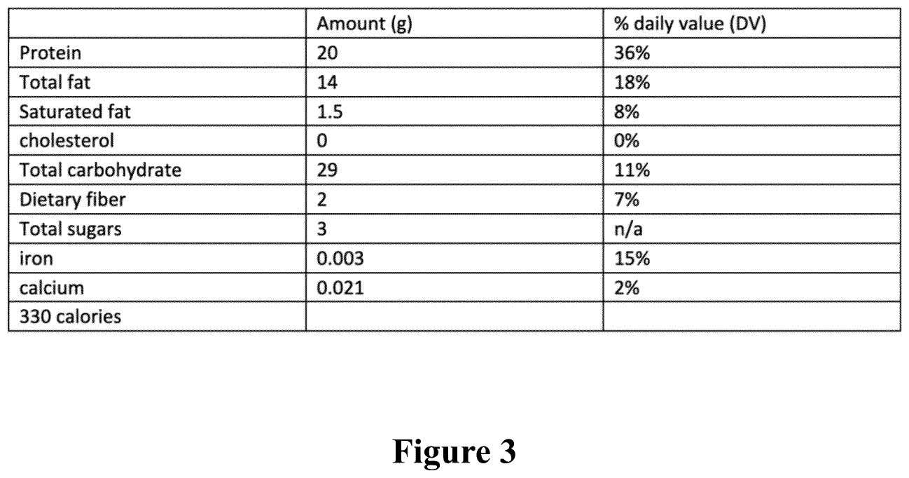

FIG. 3 is a chart containing the nutritional information of the present invention. In accordance with the preferred embodiment of the present invention, the composition of the final product contains 20 g of complete protein, 14 g of fat total, wherein 1.5 g of the total fat is saturated fat, 0 g cholesterol, 29 g of total carbohydrates wherein 2 g of the total carbohydrates includes 2 g of dietary fiber and 3 g total sugars, 3 mg of iron, and 21 mg of calcium. One serving of the product contains approximately 330 calories. The protein content of the present invention makes up 36% of the daily value, the total fat content makes up 18% of the daily value, and the total carbohydrate makes up 11% of the daily value. Furthermore, iron makes up 15% of the daily value and calcium makes up 2% of the daily value. These percentages are based on the daily value calculated from a 2,000 calorie per day diet.

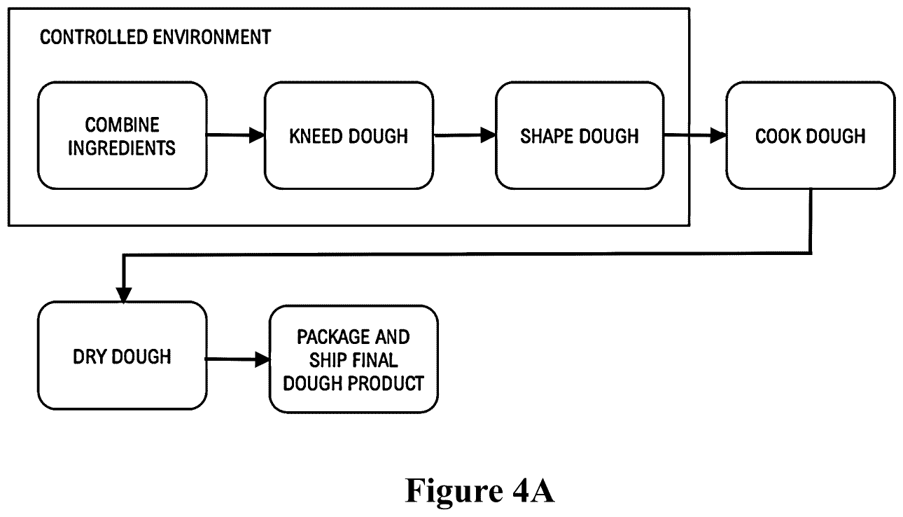

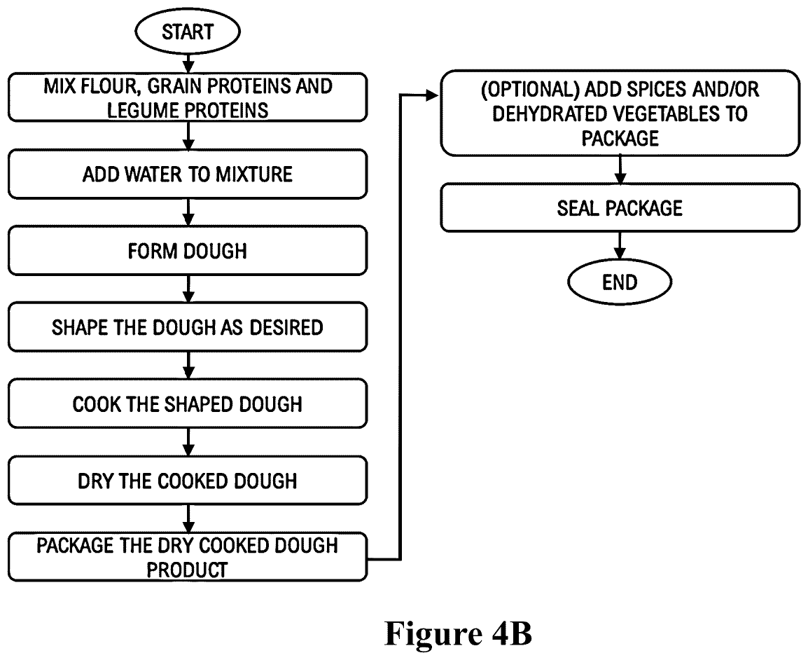

FIGS. 4A-B show the steps of the method of the present invention. Specifically, FIG. 4A shows a summary of the process. In accordance with the preferred embodiment of the present invention, the process may be summarized as follows. Ingredients for the plant-based complete protein dough are combined to form said dough, which is then kneaded and shaped. These steps are performed in a controlled environment wherein the temperature, humidity, and other environmental factors are monitored and maintained at ideal levels. The dough is then cooked and dried. The dough may be dried in small portions to increase speed of drying and to increase speed of packages post-drying. After the dough has dried, it may be packaged and shipped for retail or other purposes.

FIG. 4B shows a more detailed step by step process. In accordance with the preferred embodiment of the present invention, the process begins by combining a flour, which may be an enriched wheat flour, a gluten-free flour, a low GI flour, or other starch, and plant-based protein powders, for example a legume protein, a grain protein, or some combination thereof. In one embodiment, at least a portion of the plant-based protein is sourced from a legume, for example, green or yellow peas (any peas, etc.) and at least another portion of the plant-based protein is sourced from a grain, for example, wheat. In one embodiment, at least a portion of the flour used is whole grain flour. This dry mixture is then combined with water to form a dough. This dough is then formed into a desired shape, for example, a noodle, and cooked. The cooking process may include steaming, frying, boiling, baking, or some combination thereof. The cooked product is then portioned and dried before being packaged. Additional ingredients including but not limited to dehydrated vegetables and spices may be packaged along with the dried dough product before the package is sealed.

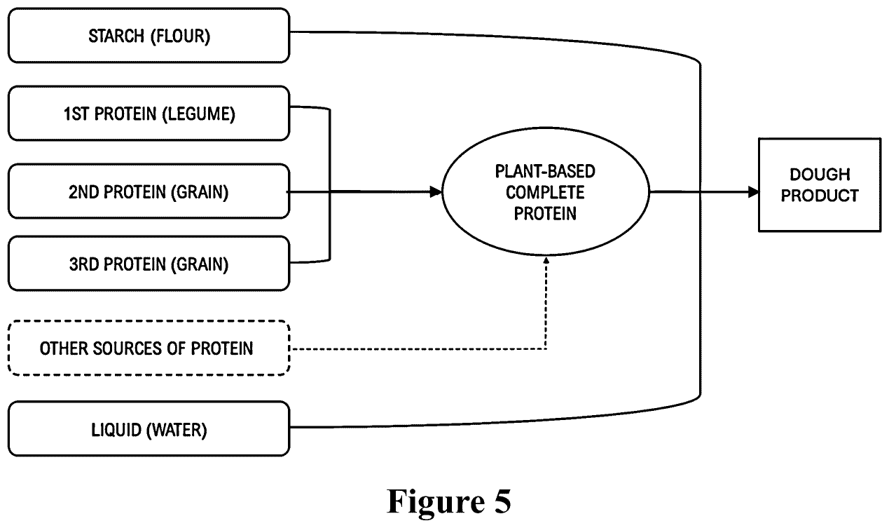

FIG. 5 summarizes the basic elements of the invention. In accordance with the preferred embodiment of the present invention, a plant-based complete protein product is formed from a first protein, a second protein, and a third protein. The first protein may be sourced from a legume. In one embodiment, the legume is a variety of pea including green, yellow peas, and any peas etc. The second and third proteins may be sourced from a grain. In one embodiment, the grain is a variety of wheat. In alternative embodiments, additional plant-based protein sources may be added to ensure adequate values of each of the nine essential amino acids are present in the final plant-based complete protein product. The plant-based complete protein product may then be combined with a starch and a liquid to form a dough containing plant-based complete protein. In the preferred embodiment, the starch may be flour and the liquid may be water. In an alternative embodiment, the starch may be a gluten-free flour and the plant-based complete protein may be developed in a way that when combined with the gluten-free flour and water, forms a gluten-free, plant-based, complete protein dough product. In another alternative embodiment, a portion of the starch may be composed of a whole grain flour. In another alternative embodiment, the starch is a flour having a low GI value.

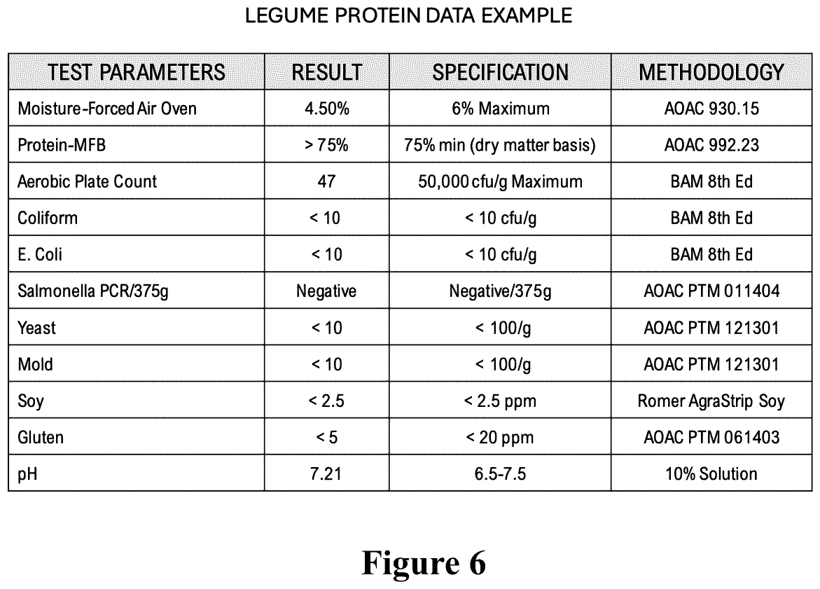

FIG. 6 shows an exemplary legume protein data sheet. In accordance with the preferred embodiment of the present invention, a first protein is sourced from a legume which meets the specification criteria shown. Specifically, a first protein source should have a maximum of 6% moisture, at least 75% protein-moisture free basis (“MFB”), at most 50,000 cfu/g aerobic plate count, less than 10 cfu/g coliform, less than 10 cfu/g E. Coli, test negative for Salmonella per 375 g, less than 100 cfu/g yeast, less than 100 cfu/g mold, less than 2.5 ppm soy, less than 20 ppm gluten, and a pH between 6.5-7.5.

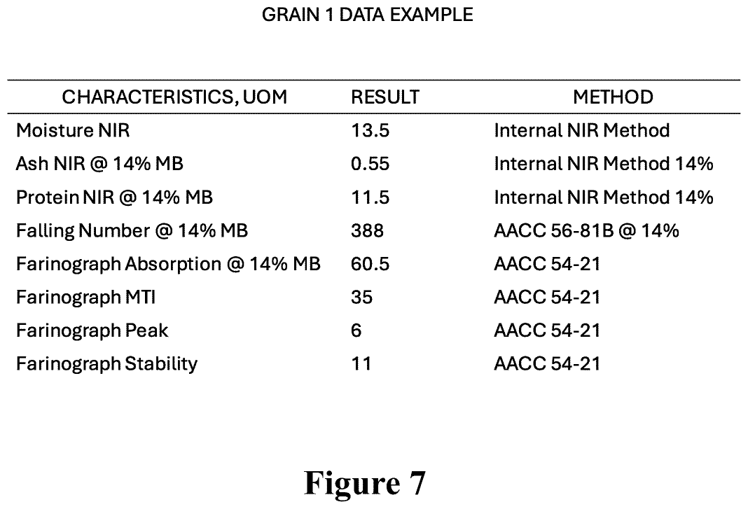

FIG. 7 shows an exemplary first grain data sheet. In accordance with the preferred embodiment of the present invention, a second protein is sourced from grain. An example of data from a suitable grain is shown. In one embodiment, the grain may have a moisture near-infrared (“NIR”) of 13.5, an ash NIR at 14% MB of 0.55, a protein NIR at 14% MB of 11.5, a falling number at 14% MB of 388, a farinograph absorption at 14% MB of 60.5, a farinograph mixing tolerance index (“MTI”) of 35, a farinograph peak of 6, and a farinograph stability of 11. These values are by way of example and are not intended to limit the scope of the present invention.

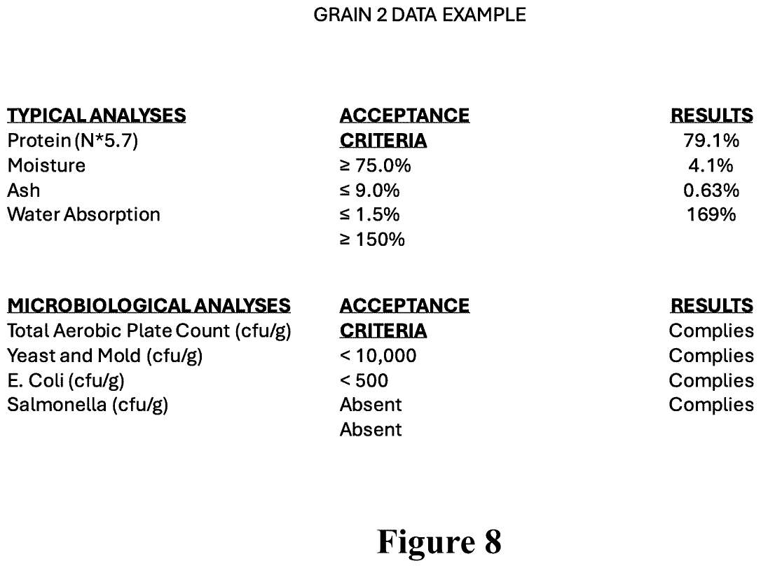

FIG. 8 shows an exemplary second grain data sheet. In accordance with the preferred embodiment of the present invention, a second grain is used which meets the acceptance criteria as shown. Specifically, the second grain should have a protein content greater than or equal to 75.0%, a moisture content less than or equal to 9.0%, an ash content of less than or equal to 1.5%, and a water absorption of greater than or equal to 150%. The results shown are by way of example and are not intended to limit the scope of the present invention. A microbiological analysis may also be completed to show that the grain used meets the accepted criteria shown. Specifically, a total aerobic plate count should be less than 10,000 cfu/g, a yeast and mold count should be less than 500 cfu/g, E. Coli and Salmonella should be absent. The results shown are by way of example and are not intended to limit the scope of the present invention.

In one embodiment, a noodle is formed from the dough product of the present invention. The noodle composition is formed by combining the dry ingredients with water and kneading the resulting dough until firm. Once the dough is prepared, it may be shaped via cutting, forming, or other methods. Once the dough is shaped as desired, for example into the shape of noodles, the noodles are cooked via frying in oil, steaming, or boiling, portioned into single servings, and then dried or frozen and packaged. An instant cooking effect (which generally refers to the noodles ability to cook to an ‘al dente’ texture in approximately three minutes) may be achieved by perfecting the moisture content of the noodles. A perfect moisture content ensures that the noodles will cook quickly without losing texture, remaining too firm or disintegrating, and maintaining the ideal “slurpability” of the noodle.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A method for making a plant-based complete protein dough, said method comprising:
formulating a dry mixture comprising grain protein, flour, and legume protein;
combining said dry mixture with water;
mixing said dry mixture and said water to form a dough;
forming a desired shape with said dough;
cooking said dough to form a cooked dough product; and
drying said cooked dough product to form a dry dough product.

2. The method of claim 1, wherein said dough is formed into a noodle shape prior to said cooking.

3. The method of claim 1, wherein said flour further comprises at least a portion of whole grain flour.

4. The method of claim 1, wherein said legume protein comprises a pea protein.

5. The method of claim 1, wherein said method further comprises a method for commerce wherein said dry dough product is portioned, packaged, and sealed in shelf-stable containers distributed for commercial distribution.

6. The method of claim 1, wherein said flour is enriched wheat flour.

7. The method of claim 1, wherein said flour is gluten-free.

8. A plant-based complete protein dough product as made by a method comprising:
formulating a dry mixture comprising grain protein, flour, and legume protein;
combining said dry mixture with water;
mixing said dry mixture with said water to form a dough;
forming a desired shape with said dough;
cooking said dough to form a cooked dough product; and
drying said cooked dough product to form a dry dough product, wherein said plant-based complete protein dough product comprises:
flour;
grain protein;
a plurality of salts;
legume protein; and
water.

9. The plant-based complete protein dough product of claim 8, wherein said flour is a gluten-free flour.

10. The plant-based complete protein dough product of claim 8, wherein said legume protein consists of pea protein.

11. The plant-based complete protein dough product of claim 8, wherein said dough is fried in an oil.

12. The plant-based complete protein dough product of claim 8, wherein said dough product is shelf-stable.

13. The plant-based complete protein dough product of claim 8, wherein said dough product is in the shape of a noodle.

14. The plant-based complete protein dough product of claim 8, wherein said flour further comprises a portion whole grain flour.

15. A system for making a plant-based complete protein dough, said system comprising:
means for mixing a dry mixture comprising grain protein, flour, and legume protein;
means for combining said dry mixture with water;
combining said dry mixture with water to form a dough;
means for forming said dough into a desired shape;
means for cooking said dough;
means for drying said dough; and
means for packaging said dough in a shelf-stable container.

16. The system of claim 15, wherein said flour further comprises a portion of whole grain flour.

17. The system of claim 15, wherein said flour is gluten-free flour.

18. The system of claim 15, wherein said means for cooking said dough comprises means for boiling said dough.

19. The system of claim 15, wherein said means for cooking said dough comprises means for steaming said dough.

20. The system of claim 15, wherein said dough is combined with a plurality of dehydrated vegetables and a plurality of powdered spices prior to packaging and sealing in said shelf-stable container.
